(19) United States
(12) Patent Application Publication
(10) Pub. No.: US 2025/0381776 A1
(43) Pub. Date: Dec. 18, 2025

(54) ELECTROHYDRODYNAMIC INKJET PRINTING DEVICES, SYSTEMS, AND METHODS

(71) Applicant: WISCONSIN ALUMNI RESEARCH FOUNDATION, MADISON, WI (US)

(72) Inventors: Hantang Qin, Middleton, WI (US); Liangkui Jiang, Madison, WI (US); Rayne Wolf, Potosi, WI (US)

(73) Assignee: WISCONSIN ALUMNI RESEARCH FOUNDATION, MADISON, WI (US)

(21) Appl. No.: 18/822,939

(22) Filed: Sep. 3, 2024

Related U.S. Application Data
(60) Provisional application No. 63/661,462, filed on Jun. 18, 2024.

(51) Int. Cl. B41J 2/045; B29C 64/112; B29C 64/209; B29C 64/393; B33Y 10/00; B33Y 30/00; B33Y 50/02; B41J 2/06; B41J 2/14; G06T 7/00

(52) U.S. Cl. CPC B41J 2/0457; B29C 64/112; B29C 64/209; B29C 64/393; B33Y 10/00; B33Y 30/00; B33Y 50/02; B41J 2/04561; B41J 2/04576; B41J 2/06; B41J 2/1433; G06T 7/001; B41J 2002/062; B41J 2002/14491

(57) ABSTRACT

An electrohydrodynamic (EHD) printing system may include a nozzle having a nozzle opening, a discharge electrode, a voltage source, an imager, and a controller in communication with the voltage source and the imager. The nozzle may be configured to contain ink and discharge the ink through the nozzle opening. The discharge electrode may be configured to be in electrical communication with the ink in the nozzle to apply voltage to the ink and create a jet of the ink discharged from the nozzle opening. The voltage source may be configured to apply the voltage to the discharge electrode. The imager may be configured to image the jet of the ink discharged. The controller may be configured to analyze the images from the imager and output control signals to the voltage source based on an analysis of the images.

### CROSS-REFERENCE TO RELATED APPLICATIONS

This application claims the benefit of U.S. Provisional Patent Application Ser. No. 63/661,462, filed Jun. 18, 2024, which is incorporated herein by reference.

### STATEMENT REGARDING FEDERALLY SPONSORED RESEARCH OR DEVELOPMENT

This invention was made with government support under 80MSFC23PA012 awarded by the NASA Marshall Space Flight Center. The government has certain rights in the invention.

### TECHNICAL FIELD

The present disclosure pertains to printing devices, systems, and methods. More particularly, the present disclosure pertains to electrohydrodynamic (EHD) printing devices, systems, and methods.

### BACKGROUND

Inkjet printing technology is known for use in printing onto paper. There are a variety of types of inkjet printing including drop-on-demand inkjet printing (e.g., electrohydrodynamic (EHD) printing, etc.) and continuous inkjet printing. Various techniques, systems, and tools are known for inkjet printing and known for use with inkjet printers. Of the known techniques, systems, and tools for or for use with inkjet printers, each has certain advantages and disadvantages.

### SUMMARY

This disclosure is directed to several alternative designs for, devices of, and methods of using electrohydrodynamic (EHD) printing systems and components therefore. Although it is noted that EHD printing systems and components therefore are known, there exists a need for improvement on those approaches and systems.

Accordingly, one illustrative example of the disclosure may include an electrohydrodynamic printing system having a nozzle including a nozzle opening, the nozzle is configured to contain ink and discharge the ink through the nozzle opening, a discharge electrode configured to be in electrical communication with ink in the nozzle to apply voltage to the ink and create a jet of the ink discharged from the nozzle opening, a voltage source configured to apply the voltage to the discharge electrode, an imager configured to image the jet of the ink discharged, and a controller in communication with the voltage source and the imager, wherein the controller may be configured to analyze images from the imager of the jet of the discharged ink, configure control signals for the voltage source for controlling the voltage applied to the discharge electrode to initiate the jet of the ink discharged from the nozzle opening based on the analysis of the images, and output the control signals to the voltage source.

Additionally or alternatively to any of the embodiments in this section, the controller may be configured to compare a profile of the jet of the ink discharged in the image to one or more thresholds and output the control signals to the voltage source based on the comparison of the profile of the jet of the ink discharged in the image to the one or more thresholds.

Additionally or alternatively to any of the embodiments in this section, the imager may be configured to image each of a plurality of jets of the ink discharged over a period of time and the controller may be configured to compare a period of the jets of the ink discharged over the period of time in the images to one or more thresholds and output the control signals to the voltage source based on the comparison of the frequency of the images of the jet of the ink discharged over the period of time to the one or more thresholds.

Additionally or alternatively to any of the embodiments in this section, the system may further include a pressure regulator in communication with the controller and configured to control a pressure applied to the ink in the nozzle, wherein the controller may be configured to output control signals to the pressure regulator for controlling the pressure applied to the ink in the nozzle based on the analysis of the images.

Additionally or alternatively to any of the embodiments in this section, the system may further include an illumination source, wherein the illumination source may be configured to illuminate a target area for the imager and the target area includes the jet of the ink discharged from the nozzle.

Additionally or alternatively to any of the embodiments in this section, the system may further include a groundless stage configured to receive a substrate having a surface to which the ink discharged from the nozzle is to be applied.

Additionally or alternatively to any of the embodiments in this section, the groundless stage may be adjustable in three dimensions.

Additionally or alternatively to any of the embodiments in this section, the system may further include a nozzle adjustment system, wherein the nozzle adjustment system may be configured to adjust a position of the nozzle in three dimensions.

Additionally or alternatively to any of the embodiments in this section, the system may further include a ground electrode configured to create an electric field with the discharge electrode.

Additionally or alternatively to any of the embodiments in this section, the system may further include a switch having a closed position in which the electric field is created between the discharge electrode and the ground electrode and an opened position in which the electric field between the discharge electrode and the ground electrode is interrupted.

Additionally or alternatively to any of the embodiments in this section, the switch may be in communication with the controller and the controller may be configured to adjust the switch to an opened position when a standoff distance between the nozzle and a surface to which the ink is to be applied is less than a threshold value and to adjust the switch to the closed position when the standoff distance is equal to or greater than the threshold value.

Additionally or alternatively to any of the embodiments in this section, the controller may be configured to output control signals to the voltage source to initiate one or more jets of ink to create a two-dimensional or three-dimension print in a micro-gravity or less environment.

In another example, a nozzle head assembly for an electrohydrodynamic printing system may include a nozzle having a nozzle opening, the nozzle is configured to contain ink and discharge the ink through the nozzle opening, a discharge electrode configured to be in electrical communication with ink in the nozzle to apply voltage to the ink and create a jet of the ink discharged from the nozzle opening, an electrical connector in electrical communication with the discharge electrode, the electrical connector is configured to electrically connect with a voltage source, and wherein the nozzle and the discharge electrode may be configured to discharge the ink in the jet of the ink independent of a ground electrode.

Additionally or alternatively to any of the embodiments in this section, the assembly may further include a ground electrode configured to create an electric field with the discharge electrode.

Additionally or alternatively to any of the embodiments in this section, the assembly may further include a switch having a closed position in which the electric field is created between the discharge electrode and the ground electrode and an opened position in which the electric field between the discharge electrode and the ground electrode is interrupted.

Additionally or alternatively to any of the embodiments in this section, the assembly may further include a mechanical connector coupled with the nozzle and configured to releasably engage a support on a printer system.

Additionally or alternatively to any of the embodiments in this section, the nozzle may be configured to output one or more jets of ink to create a two-dimensional or three-dimensional print in a micro-gravity or less environment.

In another example, a method of printing ink in a micro-gravity or less environment may include printing ink from an electrohydrodynamic printing system in the micro-gravity or less environment to form a two-dimensional or three-dimensional print.

Additionally or alternatively to any of the embodiments in this section, printing ink from the electrohydrodynamic printing system in the micro-gravity or less environment may include applying a pressure to ink in a nozzle having a nozzle opening through which the ink is printed and applying a voltage to the ink in the nozzle without using a ground electrode to receive the voltage applied to the ink, wherein the pressure and the voltage may be configured to print the ink through the nozzle opening in the micro-gravity or less environment.

Additionally or alternatively to any of the embodiments in this section, the ink may be a material selected from a group consisting of conductive material, semi-conductive material, and insulating material.

The above summary of some example embodiments is not intended to describe each disclosed embodiment or every implementation of the disclosure.

### BRIEF DESCRIPTION OF THE DRAWINGS

The disclosure may be more completely understood in consideration of the following detailed description of various embodiments in connection with the accompanying drawings, in which:

FIG. 1 is a schematic box diagram of an illustrative electrohydrodynamic (EHD) printing system;

FIG. 2 is a schematic diagram of an illustrative EHD printing system;

FIG. 3 is a schematic diagram of an illustrative EHD printing system;

FIG. 4 is a schematic diagram of an illustrative nozzle for an EHD printing system;

FIG. 5 is a schematic diagram of an illustrative nozzle for an EHD printing system;

FIG. 6 is a schematic diagram of an illustrative nozzle for an EHD printing system;

FIG. 7 is a schematic diagram of an illustrative electrical communication configuration for a nozzle of an EHD printing system;

FIG. 8 is a schematic diagram of illustrative control operations for an EHD printing system;

FIG. 9 is an illustrative screen of images of a jet of ink discharged from a nozzle of an EHD printing system and charts parameters of the jet of ink discharged relative to threshold values;

FIG. 10 is an illustrative screen of images of a jet of ink discharged from a nozzle of an EHD printing system and charts parameters of the jet of ink discharged relative to threshold values; and

FIG. 11 is a schematic box diagram of an illustrative method of printing using an EHD printing system.

While the disclosure is amenable to various modifications and alternative forms, specifics thereof have been shown by way of example in the drawings and will be described in detail. The intention is not to limit aspects of the claimed disclosure to the particular configurations described. On the contrary, the intention is to cover all modifications, equivalents, and alternatives falling within the spirit and scope of the claimed disclosure.

### DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges, and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the claimed disclosure. Selected features of any illustrative configuration may be incorporated into an additional configuration unless clearly stated to the contrary.

In-space manufacturing (e.g., manufacturing in a micro-gravity or less environment, such as a zero-gravity environment) is important and necessary for in-space exploration and becomes even more important and necessary for independent and/or long-duration traveling (e.g., to the Earth's Moon, to Mars, etc.) As such, manufacturing devices, systems, and methods that operate in a micro-gravity or less environment and improve resource efficiency (e.g., manufacturing systems that use raw materials efficiently and/or mitigate waste), reduce dependence on Earth (e.g., manufacturing systems that facilitate creating or producing tools, etc.), reduce costs (e.g., reduce a need for support missions), can be commercialized on Earth and/or in low-orbit economies, and/or that reduce environmental impacts associated with space travel (e.g., reduction of rocket launches, etc.) are desired for space travel and/or other micro-gravity or less applications. Many types of manufacturing and/or printing are unsuitable or undesirable for in-space manufacturing including, but not limited to, thermal and/or piezoelectric inkjet printing (e.g., due at least in part to a lack of gravity), aerosol jet printing (e.g., due at least in part to a lack of gravity), lithography (e.g., due at least in part to limited available space for manufacturing), physical vapor deposition (e.g., due at least in part to limited energy sources), screen printing (e.g., due at least in part to a need to recycle chemicals), etc.

Electrohydrodynamic (EHD) inkjet printing is a high-resolution additive manufacturing technology that leverages electrostatic forces to precisely deposit liquid (e.g., ink) droplets onto a substrate to create a print (e.g., an image, a three-dimensional object, a microchip, an electrical circuit, a flexible circuit, a tool, etc.) In operation, when an electric field is applied to a nozzle of an EHD printer and ink therein, a cone (e.g., a Taylor cone) of the ink may be formed at a nozzle opening (e.g., a discharge opening) of the nozzle. When the electrostatic forces through the ink overcome a surface tension and/or viscous force of the ink, jetting of the ink discharged from the nozzle opening occurs which turns into droplets of ink that are applied to a surface of a substrate. In some applications, applying the electric field to the ink in the nozzle may result in the creation of a continuous jet stream or a sequence of discrete droplets. The jet stream and/or the droplets may have widths or diameters that are smaller than a width or diameter of the nozzle opening, enabling micro and nano-scale patterning.

The disclosed EHD printing devices, systems, and methods may accommodate printing a large variety of ink materials in micro-gravity or less environments and/or other environments, where the variety of ink materials include, but are not limited to, conductive materials, semi-conductive materials, insulating materials, and/or other suitable materials. The EHD printing devices, systems, and methods may facilitate manufacturing tools, circuits, etc. from one or more types of materials.

Illustrative EHD printing devices, systems, and methods disclosed herein have been configured to print at least conductive materials, semi-conductive materials, and insulating materials in micro-gravity or less (e.g., a zero-gravity) environments. In some illustrative examples, the EHD printing devices, systems, and methods may be configured to print conductive materials, semi-conductive materials, and insulating materials in micro-gravity or less environments without the use of a ground electrode at or proximate the nozzle of the EHD printing system and/or proximate a substrate having a surface on which the ink is to be printed, which may reduce interference with other printing tools. Being able to print in a micro-gravity or less environment with a variety of materials may facilitate creating and/or manufacturing electronics, tools, etc. while in space. In some examples, utilizing the EHD printing devices, systems, and methods discussed herein to create prints (e.g., designs, objects, etc.) while in space may realize many advantages relative to using other printing and/or manufacturing techniques including, but not limited to, more easily adaptable production of different objects, reduced or mitigated material waste, improved ability to create components using multiple materials, reduced required payload space, etc.

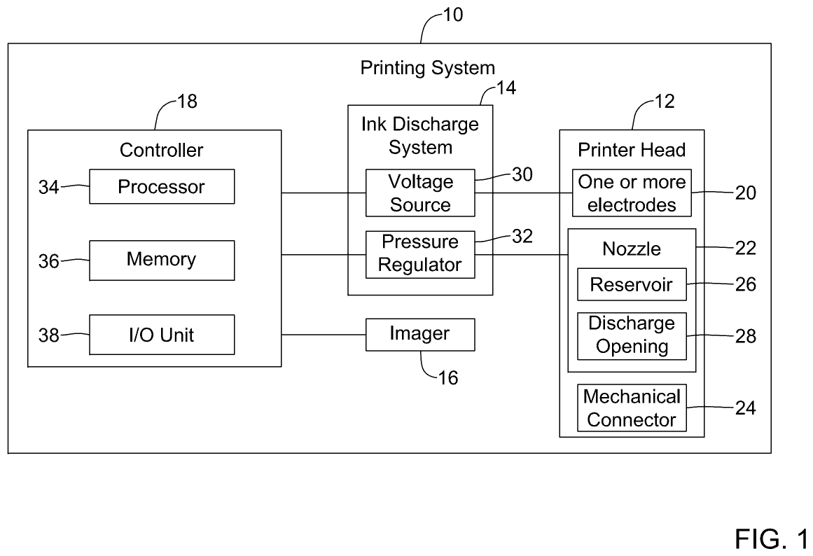

FIG. 1 depicts a schematic box diagram of an illustrative configuration of an EHD printing system 10. In some examples, the printing system 10 may include, among other components a printer head 12 (e.g., a nozzle head assembly), an ink discharge system 14, an imager 16, and a controller 18. The printing system 10, however, may include one or more additional and/or alternative components including, but not limited to, a substrate, a translating stage, a nozzle adjustment system, a movable nozzle arm, one or more motors, one or more housings, one or more windows, one or more doors, one or more lids, and/or other suitable components. In some examples, the printing system 10 may omit or may selectively use a ground electrode configured to be in communication with a voltage or electric field applied to and/or extending through ink at the printer head 12, but other suitable configurations are contemplated.

In operation of the EHD printing system 10, a user may enter control settings via a user interface at and/or in communication with the controller 18 and the controller 18 may effect printing according to or otherwise based on the control settings via the printer head 12 and the ink discharge system 14. In some examples, the controller 18 may control the printing via a closed loop system by utilizing computer vision monitoring and/or analysis of images of ink discharged from the printer head 12 and adjusting control of the nozzle 22 and/or the ink discharge system 14 while printing, as needed, based on the monitoring and/or analysis of the images from the imager 16 and/or other data received at the controller 18.

As depicted in FIG. 1, the printer head 12 may include or may be coupled with one or more components. For example, the printer head 12 may include or may be coupled with one or more electrodes 20, one or more nozzles 22, one or more mechanical connectors 24, and/or other suitable components.

The nozzle 22 may include and/or define, among other suitable components, one or more reservoirs 26 and one or more discharge openings 28 (e.g., one or more nozzle openings). The reservoir 26 may be configured to receive ink to be printed (e.g., liquid semiconducting material, liquid conducting material, liquid insulating material, and/or other suitable material) and maintain the ink for discharge during a printing process. The ink may exit the reservoir 26 during the printing process via the discharge opening 28. Although other configurations are contemplated, the nozzle 22 may be or may include a syringe defining the reservoir 26 and the discharge opening 28.

The reservoir 26 may have any suitable configuration. In one example, the reservoir 26 may have an elongated body and a tapered interior surface at a distal end of the interior surface that tapers toward the discharge opening 28, which may be located at a distal end of the reservoir 26 and/or a distal end of the nozzle 22 (e.g., the distal ends may be ends adjacent to or nearest a substrate and/or other suitable location at which a print is to be formed). Other suitable configurations of the reservoir 26 are contemplated.

The discharge opening 28 may have any suitable configuration. For example, the discharge opening 28 may have any suitable cross-sectional shape taken along an axis extending through the discharge opening 28 including, but not limited to, a circular shape, an oval shape, and/or other suitable shape. Although other configurations are contemplated, the discharge opening 28 may include a slit seal or a one-way valve to prevent or mitigate ink from unintentionally discharging from the discharge opening 28. Other suitable configurations of the discharge opening 28 are contemplated.

The one or more mechanical connectors 24 of the printer head 12 may be configured to couple (e.g., releasably or non-releasably couple) the printer head 12 with a structure of a printer. In some examples, the mechanical connector 24 may be configured to couple the printer head 12 with a movable arm of a printer, a nozzle adjustment system of a printer, and/or other suitable portion of a printer. The one or more mechanical connectors 24 may be and/or may include a clip, a clasp, a magnet, a screw, a bolt, a nut, a wingnut, and/or may have one or more other suitable configurations. The mechanical connector 24 facilitate the printer head 12 being replaceable, usable on different printers (e.g., usable on printers with or without a ground electrode at or proximate a substrate with a surface on which ink is to be printed), and/or movable between different printer head locations within a printer configured to have multiple printer heads regardless of whether a ground electrode is located at that printer head location and/or at a substrate having a surface configured to receive ink from that printer head location.

In some examples, the mechanical connector(s) 24 may be configured to create a mechanical connection and an electrical connection with one or more components of a printer, but other suitable configurations are contemplated. When the mechanical connector 24 is configured to create the electrical connection, the mechanical connector 24 may be or may include an electrical connection component including, but not limited to, a plug, a conductive prong, a conductive wire, a universal serial bus (USB), USB-C, an inductive electrical connection component, and/or other suitable type of electrical connection component. In some examples, the electrical connection component may be separate from the mechanical connector(s) 24.

The one or more electrodes 20 may have any suitable configuration configured for applying a voltage (e.g., an electrical field) to ink in the reservoir 26 and to facilitate discharging ink from the reservoir 26 in response to the applied voltage. Example suitable electrodes 20 include, but are not limited to, a discharge electrode, a ground electrode, and/or other suitable electrodes. In some examples, a discharge electrode may be configured to be in electrical communication with the ink in the reservoir 26 and to apply a voltage to the ink to create or form a cone (e.g., a Taylor cone) of ink at the discharge opening 28 and cause the ink to discharge (e.g., via a jet) from the nozzle 22 (e.g., from the discharge opening 28). In some examples, the discharge electrode may be configured to be in electrical communication with a pressure regulator (e.g., the pressure regulator 32 discussed below and/or other suitable pressure regulator) to facilitate control of a back pressure in the reservoir 26 in cooperation with a voltage applied to the ink. When the mechanical connector 24 is included with the nozzle 22 and includes an electrical connection component, the discharge electrode may be in electrical communication with and/or may be the electrical connection component.

In some examples, the printing system 10 may omit a ground electrode from an electrical circuit for applying the voltage to the ink in the nozzle 22 and/or may be configured to apply the voltage to the ink in the nozzle 22 without the use of a ground electrode at or proximate the nozzle 22 and/or at a substrate having a surface configured to receive ink from the nozzle 22, such that the printing system 10 may be a groundless EHD printing system. When included in the printing system 10, the ground electrode may be located at a substrate and spaced away from the nozzle 22 and/or the ground electrode may be located at and/or proximate the nozzle 22.

The one or more electrodes 20 may have any suitable shape and/or size for facilitating application of a voltage and/or electric field to the ink in the reservoir 26. For example, the one or more electrodes 20 may be elongated, may be ring-shaped, may be a wire, may be sheet-shaped, may be a coating on a surface of the nozzle 22 (e.g., an interior surface and/or other suitable surface) and/or may have one or more other suitable shapes and/or sizes. In one example, the discharge electrode may be elongated and configured to extend into the reservoir 26 (e.g., into the ink in the reservoir 26). In one example, the ground electrode may be a ring electrode configured to extend between the nozzle 22 and a substrate configured to receive ink from the nozzle 22. Other suitable configurations of the one or more electrodes 20 are contemplated.

The ink discharge system 14 may be in communication (e.g., electrical communication, mechanical communication, etc.) with the printer head 12 and/or the controller 18. In some examples, the ink discharge system 14 may be entirely part of or may include one or more components that are part of the printer head 12 and/or the controller 18. In some examples, the ink discharge system 14 may be entirely separate from or may include one or more components that are separate from the printer head 12 and/or the controller 18.

The ink discharge system 14 may include any suitable components configured to facilitate discharging ink from the nozzle 22. In some examples, the ink discharge system 14 may include, among additional and/or alternative components, a voltage source 30 and a pressure regulator 32.

The voltage source 30 may have any suitable configuration configured to apply voltage and/or an electric field to ink in the nozzle 22 of the printer head 12 in response to electrical signals (e.g., control signals) and/or other signals from the controller 18. In some examples, the voltage source 30 may include, but is not limited to, a waveform generator, a voltage amplifier, and/or other suitable components. In some examples, the voltage source 30 may include an electrical and/or mechanical connection with a battery, line power, and/or other suitable source of power for generating a voltage. When included, the wave form generator may generate a voltage pulse or wave (e.g., a voltage signal) in response to received control signal(s) from the controller 18 and/or other suitable control signals and the voltage amplifier may amplify the voltage pulse or wave according to the control signal(s) received from the controller 18 and/or other suitable control signals. An amplitude, frequency, and duty ratio may be set by and/or may be set in response to the control signal from the controller 18 and/or other source of control signals and may be configured to establish a desired print resolution and/or precision. Other suitable configurations of the voltage source 30 are contemplated.

Establishing and maintaining a desired pressure (e.g., a desired backpressure) in the reservoir 26 (e.g., a desired backpressure applied to ink in the nozzle 22) may facilitate an overall stability and repeatability of the printing process. The pressure regulator 32 may have any suitable configuration for establishing and/or maintaining such a desired pressure in the reservoir 26. In some examples, the pressure regulator 32 may be and/or may include a mechanical system configured to advance a plunger (e.g., the plunger may be part of the pressure regulator 32 and/or part of the nozzle 22 (e.g., part of the printer head 12)) proximally and/or distally in the reservoir 26, a fluid system configured to add and/or remove fluid that will not mix with the ink into and/or from the reservoir 26, and/or one or more other suitable systems configured to establish and/or maintain a pressure in the reservoir 26. In some examples, a pressure sensor of or separate from the pressure regulator 32 may sense a pressure or other suitable measure related to pressure in the reservoir 26 and communicate the sensed pressure or other suitable measure to the controller 18 and/or the pressure regulator 32 as part of a closed loop feedback system for controlling pressure in the reservoir 26 and, more generally, for controlling the printing system 10. Other suitable configurations of the pressure regulator 32 are contemplated.

The imager 16 may be configured to take and/or capture images of a cone at the discharge opening 28, a jet of ink discharged from the discharge opening 28 of the nozzle 22, droplets of the ink discharged, etc. The imager 16 may be focused on a distal end of the nozzle 22 and/or a space distal of the nozzle 22 extending entirely or at least partially between the nozzle 22 and a location of the print. In some examples, the imager 16 may include and/or may be in communication with a highspeed camera and/or one or more illumination sources. The images of the cone, the ink jet, the droplets, and/or other desired targets from the imager 16 may be provided to the controller 18 for processing as part of the computer vision system, which may be part of monitoring and/or controlling the EHD ink jetting process in a closed-loop manner.

The imager 16 may utilize any suitable highspeed camera. In some examples, a suitable highspeed camera may be any suitable camera capable of capturing 10,000 frames per second (fps) or more. Other suitable highspeed cameras are contemplated.

As depicted in FIG. 1, the controller 18 may be in communication with the ink discharge system 14 (e.g., the voltage source 30, the pressure regulator 32, and/or other suitable discharge components), the imager 16, and/or other suitable components. In some examples, the controller 18 may be configured to receive data from and/or control the ink discharge system 14, the imager 16, and/or other suitable components of the printing system 10 before, during, and/or after a printing process. The controller 18 may receive and/or determine control parameters (e.g., parameters including, but not limited to, voltage frequency, voltage amplitude, reservoir pressure, duty ratio, printing speed, standoff distance between the nozzle 22 and a printing surface (e.g., a stage, a substrate, a layer of a print, etc.), etc.) for achieving a print having a desired configuration (e.g., a print having a desired set of printing parameters) with the printing system 10 and may use data collected by the ink discharge system 14 and/or the imager 16 to determine control signals for the ink discharge system 14 in order to control the printer system 10 components according to the control parameters to create the desired print. In some examples, the controller 18 may be continuously monitoring data, adjusting control parameters, and outputting control signals to the ink discharge system 14 based on collected data to create a desired print, but other suitable configurations are contemplated.

The controller 18 may be any suitable controller configured to control components of the printing system 10 based on user input (e.g., control settings, printer settings, parameters for a print job, etc.), data collected from components of the printing system 10 before, during, and/or after the printing process (e.g., images from the imager 16, measurements taken from images (e.g., by a suitable computer vision algorithm, etc.), a pressure in reservoir 26, printing parameters, etc.), and/or process or analyze of the collected data and user input. The controller 18 may be configured to process and/or analyze collected data and user inputs and/or the processing and/or analyzing of the collected data and user inputs may be performed remotely from the controller 18. In some cases, the controller 18 may be or may include a PID controller (proportional-integral-derivative controller) to facilitate a closed loop control of the printing system 10 and/or for other purposes, but other suitable configurations of the controller 18 are contemplated.

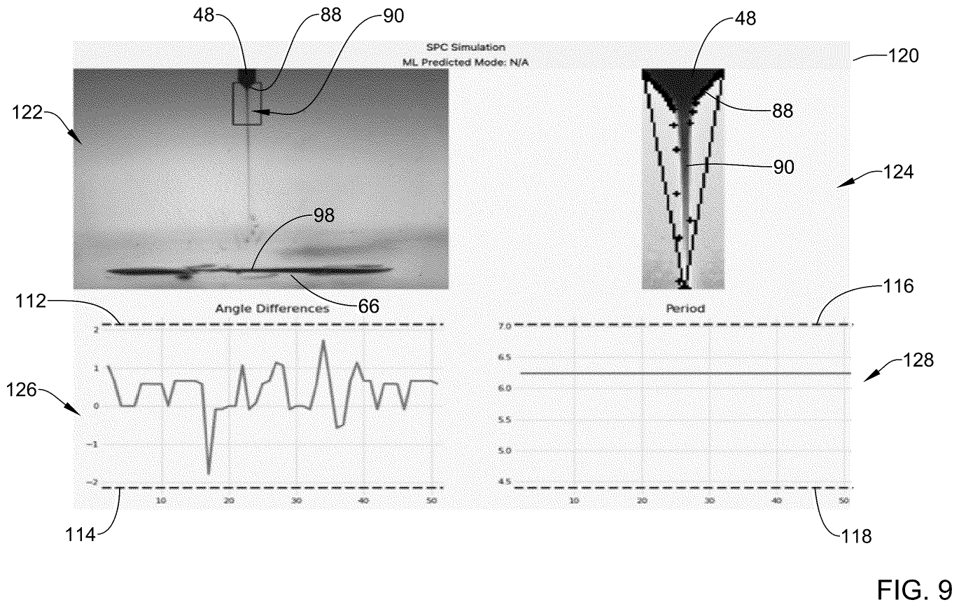

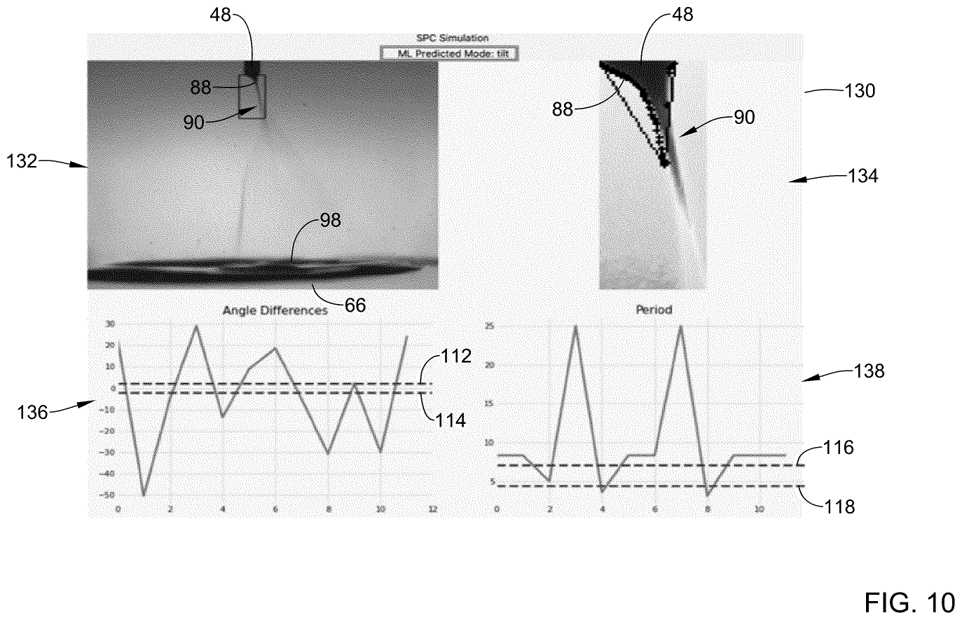

The controller 18 may utilize a machine learning model. For example, the controller 18 may be configured to make one or more decisions based on predictions from a machine learning model trained on the user input data, data collected from the printing system 10 before, during, and/or after the printing process, data concerning the quality of prints, and/or the processing or analysis of the input data and/or the collected data. In one example, the controller 18 may utilize a computer vision algorithm or analysis technique to analyze images. The machine learning model may determine or predict a jetting mode of the printing process (e.g., as discussed in further detail with respect to FIGS. 9 and 10), a status of the printing process, and/or set control parameters or control signals based, at least in part, on outputs from the computer vision algorithm. In some examples, the computer vision algorithm may be part of the machine learning model. When the PID controller is utilized as, as part of, or with the controller 18, the controller 18 may utilize the machine learning model in the closed-loop control. The controller 18 or at least a portion of the controller 18 may be a component of the printing system 10, as depicted for example in FIG. 1. Alternatively or additionally, the controller 18 or at least a portion of the controller 18 may be separate from the printing system 10. In some examples, the controller 18 may be in a single housing.

Alternatively, the controller 18 may be implemented in two or more housings. Further, in some cases, at least part of the controller 18 may be implemented in or on a remote server (e.g., in a cloud system) and may communicate with one or more other components of the controller 18 over one or more wired and/or wireless networks.

The illustrative controller 18 may include, among other suitable components, one or more processors 34, memory 36, and/or one or more I/O units 38. Other suitable example components of the controller 18 that are not necessarily depicted in FIG. 1 may include, but are not limited to, communication components, a user interface, a touch screen, a display screen, selectable buttons, a housing, and/or other suitable components of a controller 18. As discussed above, one or more components of the controller 18 may be separate from the printing system 10 and/or incorporated into the printing system 10, as depicted in FIG. 1.

The processor 34 of the controller 18 may include a single processor or more than one processor working individually or with one another. The processor 34 may be configured to execute instructions, including instructions that may be loaded into the memory 36 and/or other suitable memory. Example components of the processor 34 may include, but are not limited to, microprocessors, microcontrollers, multi-core processors, central processing units, graphical processing units, digital signal processors, application specific integrated circuits (ASICs), field programmable gate arrays (FPGAs), discrete circuitry, and/or other suitable types of data processing devices.

The memory 36 of the controller 18 may include a single memory component or more than one memory component each working individually or with one another. Example types of memory 36 may include random access memory (RAM), EEPROM, FLASH, suitable volatile storage devices, suitable non-volatile storage devices, persistent memory (e.g., read only memory (ROM), hard drive, Flash memory, optical disc memory, and/or other suitable persistent memory) and/or other suitable types of memory. The memory 36 may be or may include a transitory and/or a non-transitory computer readable medium. The memory 36 may include instructions executable by the processor 34 to cause the processor 34 to effect the methods and/or techniques discussed herein.

The I/O units 38 of the controller 18 may include a single I/O component or more than one I/O component each working individually or with one another. Example I/O units 38 may be or may include any suitable types of communication hardware and/or software including, but not limited to, communication ports configured to communicate with the printing system 10 and/or other suitable computing devices or systems. Example types of I/O units 38 may include wired ports, wireless ports, radio frequency (RF) ports, Low-Energy Bluetooth ports, Bluetooth ports, Near-Field Communication (NFC) ports, HDMI ports, WiFi ports, Ethernet ports, VGA ports, serial ports, parallel ports, component video ports, S-video ports, composite audio/video ports, DVI ports, USB ports, optical ports, and/or other suitable ports.

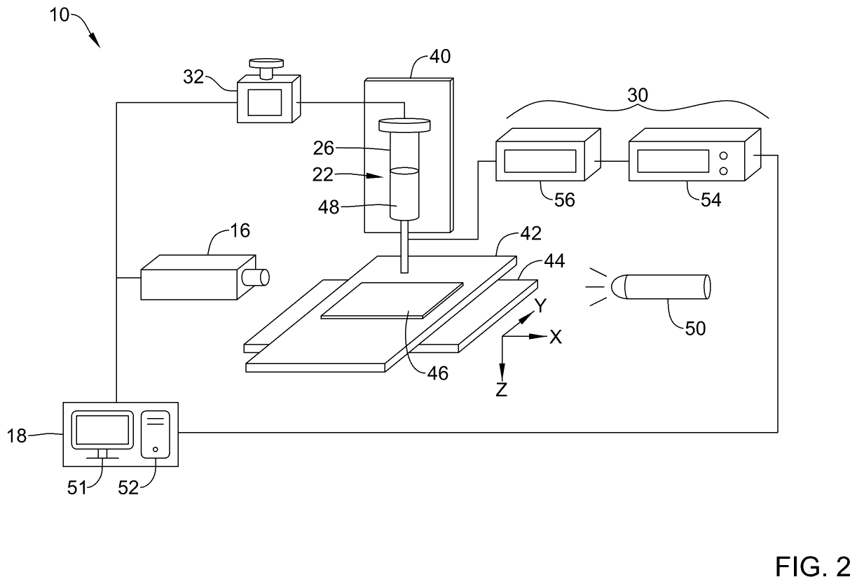

FIG. 2 depicts a schematic diagram of an illustrative configuration of the printing system 10, which depicts illustrative connections between components of the printing system 10. Among other components, the printing system 10 depicted in FIG. 2 may include the nozzle 22 (e.g., a syringe), one or more translating stages, a waveform generator 54, a voltage amplifier 56, the imager 16 (e.g., a highspeed camera and/or other suitable imager), the pressure regulator 32, an illumination source 50, and the controller 18.

The one or more adjustable stages of the printing system 10 may be configured to adjust in one or more axes (e.g., in the x-axis, y-axis, and/or z-axis) and/or may be non-adjustable stages. As depicted in FIG. 2, the printing system 10 may include a translating first stage 40 configured to couple with the nozzle 22 for controlling a position of the nozzle 22 relative to a printing surface, a translating second stage 42 (e.g., a substrate or other suitable stage) configured to support a print 46 printed from ink 48 in the reservoir 26 thereon, and a translating third stage 44 configured to receive and/or support the second stage 42. Additional and/or alternative stages may be utilized. Although other configurations are contemplated, one or more of the stages may be configured to adjust in all three axes, configured to adjust in less than all three axes, configured for fine adjustments, configured for coarse adjustments, and/or may be configured in one or more other suitable manners to facilitate the printing process. In one example, the second stage 42 may be a substrate having a surface to which ink discharged from nozzle 22 is to be applied and the third stage 44 may be a groundless stage adjustable in three dimensions and configured to receive the second stage 42. In some examples, the first stage 40 and/or one or more other suitable stages may form or may be part of a nozzle adjustment system (e.g., a nozzle adjustment system adjustable in one or more dimensions, such as one dimension, two dimensions, three dimensions, etc.) and the second stage 42 and/or the third stage 44 may be omitted and/or may have fixed positions within the printing system 10. When an electrode between the first stage 40, the second stage 42, the third stage 44, and/or other stages of the printing system 10 and a substrate having a surface on which a print is to be printed is omitted, the printing system 10 may be considered a groundless printing system 10.

One or more motors, one or more gantry systems (e.g., one or more nozzle adjustment systems), and/or other suitable adjustment mechanisms may be in communication with the stages 40, 42, 44 and the controller 18 (e.g., a computing device 51, such as a mini computer or other suitable computer, a mobile device 52, a server, etc.). The motors may initiate and/or effect movement of one or more of the stages in response to control signals from the controller 18.

As depicted and discussed, the voltage source 30, the pressure regulator 32, and the imager 16 (e.g., a highspeed camera) may be in communication with the controller 18 to facilitate controlling the jet of ink discharging from the nozzle 22 based entirely or at least in part on one or more computer vision analyses of images from the imager 16. In some examples, the controller 18 may determine control signals for the pressure regulator 32, a waveform generator 54, a voltage amplifier 56, the one or more translating stages, and/or other electronic components of the printing system 10 based on printing parameters that have been set at and/or sent to the controller 18, the computer vision analyses of images from the imager 16, and/or analysis of other data received at the controller 18. Additionally or alternatively, the controller 18 may provide control signals to the imager 16 and/or an illumination source 50 (e.g., one or more light emitting diodes and/or other suitable types of illumination), where the illumination source 50 may be configured to illuminate a target area to be imaged by the imager 16 (e.g., a target area comprising a scene that includes a ink cone, an ink jet, and/or other features of the printing process) and may be part of and/or separate from (e.g., as depicted in FIG. 2) the imager 16.

Any suitable illumination source 50 may be utilized including, but not limited to, an illumination source 50 emitting white light covering a wavelength from 300 nanometers (nm) to 1000 nm. Other suitable illumination sources are contemplated.

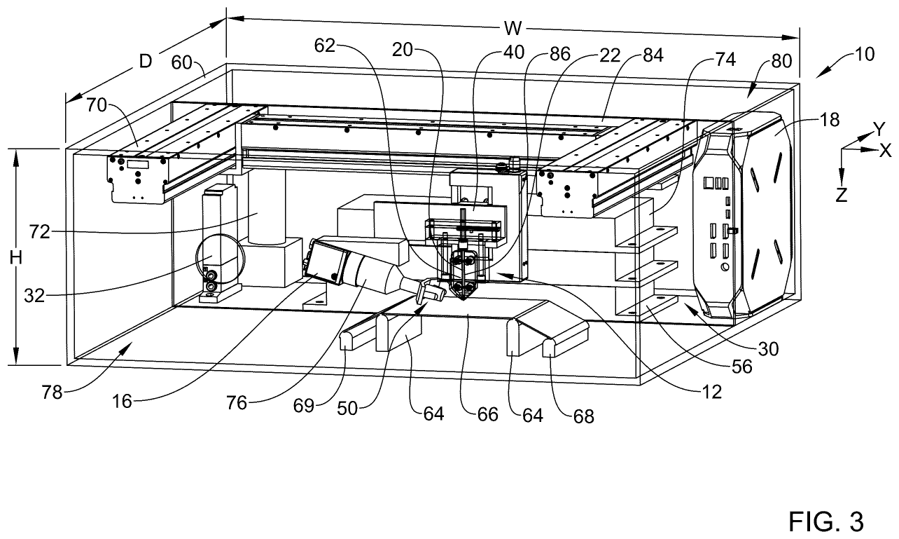

FIG. 3 depicts a schematic perspective view of an illustrative configuration of the printing system 10 having a housing 60. The housing 60 may be configured to house one or more printer heads 12, one or more imagers 16, one or more controllers 18, one or more voltage sources 30, one or more pressure regulators 32, one or more first stages 40 configured to adjust the printer head 12 and/or other stages, one or more illumination sources 50, one or more substrate supports 64, one or more substrates 66, one or more substrate collectors 68, one or more substrate feeders 69, one or more gantry systems 70, one or more pressure pumps 72, one or more stage controllers 74, one or more prints 46, and/or other suitable components. In some examples, the housing 60 may be configured to protect the print 46 from contamination. In one example (e.g., including when working in an outer space environment, etc.), the housing 60 may be configured to protect components of the printing system 10 and/or the print(s) 46 from radiation.

The housing 60 may have any suitable configuration. For example, the housing 60 may have a transparent or window portion configured to allow viewing of a print and/or internal components of the printing system 10, a lid, a door, and/or other suitable features or components. In one example, the housing 60 may include a transparent window to allow users to view a print as it is printed and a door configured to allow users to remove the print from the housing 60 and/or to allow users to interact with components of the printing system 10 (e.g., to allow users to replace or switch out the printer head(s) 12, add ink to the nozzle 22, etc.)

The housing 60 may have any suitable shape and/or size. In some examples, the housing 60 may have a width W within a range from about 381 millimeters (mm) (15 inches) to about 635 mm (25 inches), a depth D within a range from about 381 mm (15 inches) to about 635 mm (25 inches), and a height H within a range from about 127 mm (5 inches) to about 381 mm (15 inches) and/or other suitable dimensions. In one example, the housing 60 may have a width of about 482.6 mm (19 inches), a depth of about 482.6 mm (19 inches), and a height H of about 177.8 mm (7 inches). In some examples, the housing 60 may be sized such that the printing system may fit within a 4U rack, but other suitable configurations are contemplated.

The housing 60 may include one or more compartments. For example, the housing 60 may include a single compartment, two compartments, three compartments, five compartments, and/or other suitable number of compartments. In one example, the housing 60 may include a first compartment 78 configured to house at least the printer head 12 and may include a location at which the printing may occur and a second compartment 80 may be configured to house control components (e.g., the controller 18, voltage source 30, the pressure regulator 32, the stage controller 74, etc.) and/or other suitable components. Other suitable configurations of compartments of the housing 60 are contemplated.

In the second compartment 80 of the housing 60 depicted in FIG. 3, the control components may be in communication with one another to facilitate operation of the printing system 10 and printing a print in the first compartment 78 according to print parameters. For example, the controller 18 may be in communication with one or more of the voltage source 30, the pressure regulator 32, the pressure pump 72, the stage controller 74, and/or other suitable components via one or more wired or wireless connections. Alternatively or additionally, one or more control components may be located exterior of the second compartment 80 and/or exterior of the housing 60.

In some examples, one or more components in the second compartment 80 may be in communication with one or more components in the first compartment 78 to effect printing the print. In one example, the controller 18 may be in communication with the imager 16 having a lens 76 and/or the illumination source 50 to provide control signals thereto and/or to receive data (e.g., images, time stamps, etc.) therefrom.

The gantry system 70 (e.g., a nozzle and/or substrate positioning system) may have any suitable configuration for adjusting a position of the printer head 12 relative to a surface on which the print is to be made (e.g., a surface of the substrate 66). In some examples, the gantry system 70 may include, among other components, one or more fixed arms 82 configured to be fixed relative to the housing 60, a first adjustable arm 84 configured to translate in a first axis (e.g., the y-axis, as depicted in FIG. 3) and a second adjustable arm 86 configured to translate in a second axis (e.g., the x-axis in FIG. 3). The second adjustable arm 86 may be coupled with the first stage 40 in a manner that facilitates translating the first stage in a third axis (e.g., the z-axis). When a control signal is sent to the stage controller 74 to position the printer head 12 (e.g., the nozzle 22) at a desired location, the stage controller 74 may actuate one or more motors and/or other suitable adjustment mechanisms to move one or more of the first adjustable arm 84, the second adjustable arm 86, and/or the first stage 40 to position the printer head 12 at the desired location. Other suitable configurations of the gantry system 70 and/or other suitable systems for positioning the printer head 12 (e.g., nozzle adjustment systems) are contemplated.

As discussed, the controller 18 may output control signals to the stage controller 74 to adjust a position of the gantry system 70 to position the printer head 12 at a desired location for discharging ink from the nozzle 22 onto the substrate 66. In some examples, the substrate 66 may be supported by one or more substrate supports 64 and when the substrate 66 is a flexible substrate, the substrate 66 may be collected at the substrate collector 68 and/or fed to the substrate collector 68 by the substrate feeder 69. In some examples, the substrate collector 68 and/or the substrate feeder 69 may be in communication with the controller 18 and the controller 18 may be configured to provide control signals to the substrate collector 68 and/or the substrate feeder 69 to collect and/or feed the substrate 66 at a rate to facilitate achieving one or more print parameters. In some examples, one or both of the substrate collector 68 and the substrate feeder 69 may be omitted or may be not be controllable by the controller 18 (e.g., one or both of the substrate collector 68 and the substrate feeder 69 may be only a support).

Once the printer head 12 is at a desired location, the controller 18 may provide control signals to other components of the printing system 10 to initiate printing ink from the nozzle 22. For example, the controller 18 may provide control signals to the pressure regulator 32, which may in turn cause the pressure pump 72 to adjust or maintain pressure in the nozzle 22, to the imager 16 to image ink discharged from the nozzle 22, to the voltage source 30 to initiate a voltage or an electric field to be applied to ink in the nozzle 22 via the discharge electrode 62, to the substrate collector 68 and/or the substrate feeder 69 to adjust a position of the substrate 66, and/or to one or more other suitable components. In some examples, the nozzle 22 and the discharge electrode 62 may be configured to discharge jets of ink independent of a ground electrode at or proximate the substrate 66 and/or the nozzle 22 (e.g., without using a ground electrode to create an electric field with the discharge electrode 62), as depicted in FIG. 3. In one example, the controller 18 outputting control signals to the pressure regulator 32 to apply a desired pressure to the ink in the nozzle 22 and/or the voltage source 30 to apply a desired voltage or electric field to the ink in the nozzle may initiate one or more jets of ink to create a two-dimension or three-dimensional print in a micro-gravity or less environment without or independent of a ground electrode configured to receive the voltage or electric field applied to the ink. The closed-loop control systems discussed herein that may continuously adjust process or control parameters facilitate printing prints in a groundless environment (e.g., without using a ground electrode to create an electric field with the discharge electrode 62) that have desired configurations (e.g., desired printing parameters).

As ink is discharged from the nozzle 22 and printed onto the substrate 66, the controller 18 may receive data (e.g., measures of and/or related to pressure in or at the nozzle 22, images, measures related to an electric field at the ink in the nozzle 22, etc.) from the pressure regulator 32, the imager 16, the voltage source 30, and/or other suitable components. The controller 18 may analyze images of jets of ink discharged from the nozzle 22 and/or other data from the voltage source 30, the pressure regulator 32, and/or other components of the printing system 10. Based on user input and/or the analysis of the images and/or other data, the controller 18 may configure and output control signals to the pressure regulator 32, to the imager 16, to the voltage source 30, to the substrate collector 68 and/or the substrate feeder 69, to the stage controller 74, and/or to one or more other suitable components based on the analysis of the images from the imager 16 and/or other data received. In one example, the controller 18 may be configured to analyze images from the imager 16 of a jet of ink discharged from the nozzle 22, configure control signals for the voltage source 30 and/or the pressure regulator 32 for controlling the voltage applied to the discharge electrode 62 and/or pressure in the reservoir 26 of the nozzle 22 to initiate the jet of the ink discharged from the discharge opening 28 in a desired manner based on the analysis of the images, and output the control signals to the voltage source 30 and/or the pressure regulator 32.

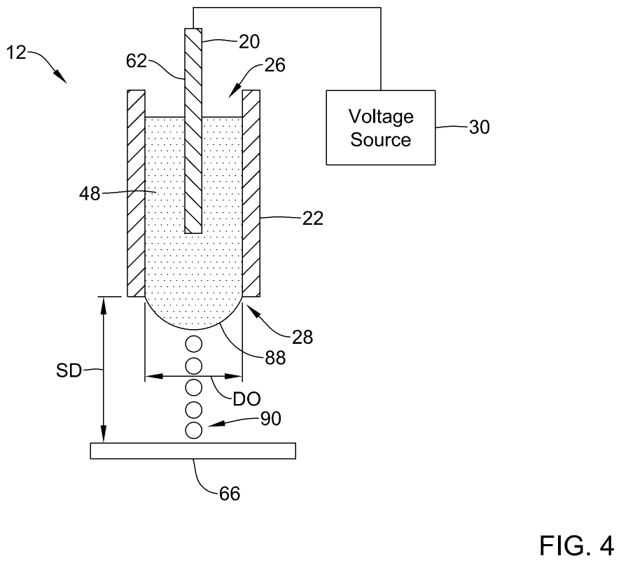

For in-space manufacturing, manufacturing technologies (e.g., three-dimensional (3D) printing technologies, EHD printing technology, etc.) are constrained by limited payload space. As such, the printing system 10 or components thereof may be modular and the printer head 12 may be configured to be installed on and/or otherwise configured to releasably couple with an arm of the printing system 10 and/or be one of multiple printheads of the printing system 10. FIG. 4 depicts a schematic diagram of an illustrative configuration of the printer head 12 relative to the voltage source 30 and the substrate 66, with the one or more electrodes 20 (e.g., the discharge electrode 62) extending into the ink 48. In some example configurations, the printer head 12 may be configured to be releasably coupled to one or more stages of the printing system 10 so as to be replaceable such that a nozzle size can be changed, a discharge opening size can be changed, a nozzle fully loaded with ink may be used in the printing system 10, etc.

As discussed and as depicted in FIG. 4, the one or more electrodes 20 may include the discharge electrode 62 and a ground electrode may be omitted. Omitting a ground electrode from the printing system 10 (e.g., from a location proximate the substrate 66 and/or the nozzle 22) may facilitate printing in low or zero gravity conditions and allows for more freedom in system design as the ground electrode may interfere with other tools utilized with the printing system 10. For example, when the printing system 10 is integrated with other tools (e.g., for use in compact environments including, but not limited to, a space environment, etc.) including, but not limited to, fused deposition modeling (FDM) systems, laser sintering systems, laser scanning systems, micro-machining systems, etc., the systems may share a gantry, stages, substrates, holders, etc. and utilizing a ground electrode between the stages and the substrate (e.g., to create an electrical connection with the discharge electrode 62) for the printing system 10 may interfere with operations of these other systems or tools. In one example, the ground electrode, when included in the printing system 10 between the stages and the substrate may interfere with a heated bed of an FDM system. In another example, laser sintering systems may be affected by a ground electrode positioned between the stages and the substrate due to a good thermal conductivity of the ground electrode transferring heat away from a desired location while laser sintering. In another example, when a conductive substrate (e.g., an electrically conductive metal, etc.) can result in a short circuit of a voltage amplifier if a ground electrode is present at or proximate the conductive substrate.

As depicted in FIG. 4, the ink 48 may be in the reservoir 26 of the nozzle 22 and the discharge electrode 62 may extend into the ink 48 within the reservoir 26. Although the discharge electrode 62 is depicted in FIG. 4 as extending into the ink 48, other suitable positioning of the discharge electrode 62 is contemplated.

As discussed, the discharge electrode 62 may be in electrical communication with the voltage source 30 and may receive a voltage or other suitable power from the voltage source 30 to cause the ink 48 to discharge from the discharge opening 28 of the nozzle 22. In operation, the discharge electrode 62 may receive a voltage from the voltage source 30, which creates an electric field across the ink and causes the ink, which may be under a pressure, to discharge through the discharge opening 28 to the substrate 66.

As the ink 58 is discharging from the discharge opening 28, the ink 58 may form a cone 88. As the electric field is applied to the ink 58 and the surface tension and/or viscosity forces of the ink 58 are overcome, the ink 58 may discharge as a jet 90 of ink 58 (e.g., represented by a plurality of circles in FIG. 4) to a location on the substrate 66. In some examples, the cone 88 and the jet 90 of ink 58 may extend an entirety of or at least a part of a standoff distance SD from the discharge opening 28 to the substrate 66.

The discharge opening 28 may have any suitable width or diameter DO. In some examples, the discharge opening 28 may have a width or diameter DO in a range from about 1 micron to about 500 microns. Other suitable widths and/or diameters DO of the discharge opening 28 are contemplated.

The standoff distance SD may have any suitable length. In some examples, the standoff distance SD may have a length in a range from about zero mm to about 1000 mm. Other suitable lengths of standoff distances SD are contemplated.

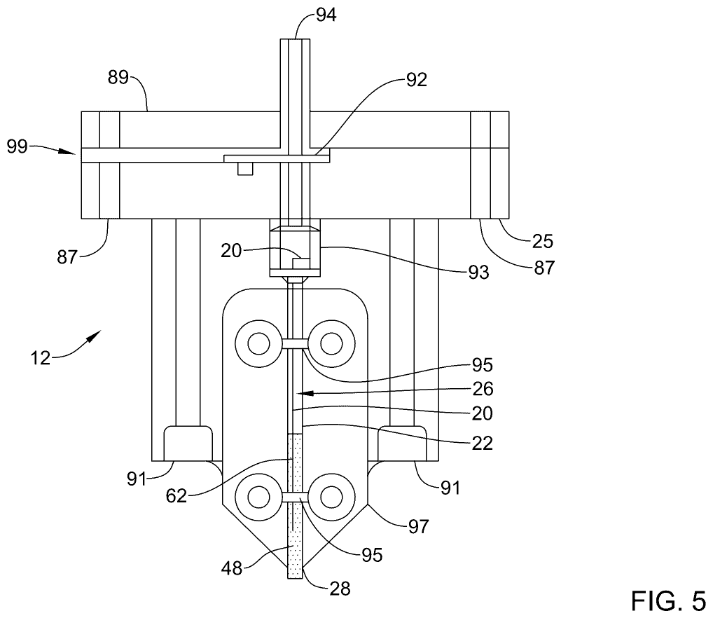

FIG. 5 depicts a schematic diagram of an illustrative configuration of the printer head 12 configured to be releasably coupled (e.g., mechanically and/or electrically coupled) with one or more components of the printing system 10. The nozzle 22 of the printer head 12 may be releasably coupled with the first stage 40 (e.g., a stage configured to move in the z-axis, not shown in FIG. 5) and/or one or more other nozzle adjustment mechanisms via the mechanical connector 24 to facilitate translation of the nozzle 22 relative to a printing surface.

The one or more electrodes 20 of the printer head 12 may include the discharge electrode 62. Although other configurations of the discharge electrode 62 are contemplated, the discharge electrode 62 may be a copper wire inserted into the nozzle 22. The discharge electrode 62 may be electrically and/or mechanically coupled with an electrical conductor 93 (e.g., a copper conductor), which may be in electrical communication with an electrode connector 92, but other suitable configurations are contemplated. The printer head 12 may omit a ground electrode, as depicted for example in FIG. 5. Other suitable configurations are contemplated in which a ground electrode may be included with the printer head 12.

The nozzle 22 may have any suitable configuration for defining a reservoir 26 (not shown in FIG. 5) configured to receive the ink 48. In some examples, the nozzle 22 may be formed from a glass material and/or other suitable material that defines the reservoir 26. In some examples, the nozzle 22 may be elongate and/or have a tapered end for dispensing the ink 48.

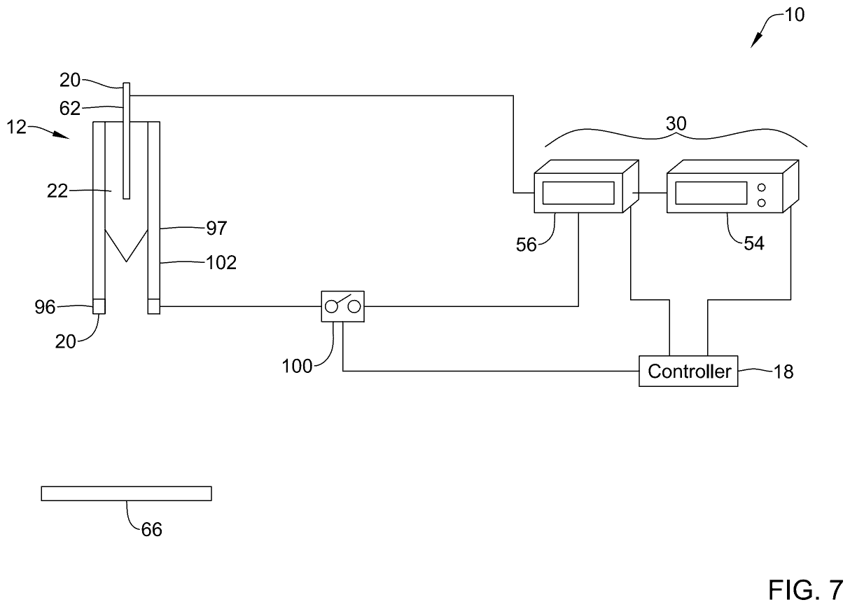

A cover 97 may extend over the nozzle 22 to protect the nozzle 22 and/or for other suitable purposes. Although other configurations of the nozzle 22 and/or the printer head 12 that omit a cover or form a cover out of another material are contemplated, an insulating material may form the cover 97 extending over the glass material or other material forming the nozzle 22 defining the reservoir 26. In some examples, the glass material defining the reservoir 26 may be an insulating material such that the cover 97 may be omitted or the cover 97 may be formed from the glass material. The insulating material/cover is discussed further with respect to FIG. 7.

The cover 97, when included, may be coupled with the nozzle 22 and/or other components of the printer head 12 in any suitable manner. In some examples, the cover 97 may be detachably coupled with the nozzle 22 and/or other components of the printer head 12 utilizing o-rings 95 and/or other suitable connectors. In some examples, the o-rings 95 and/or other suitable connectors may be configured to align an opening of the cover 97 with the nozzle 22 (e.g., a distal end or discharge end of the nozzle 22) such that the nozzle 22 may be extended out of opening, but other suitable configurations are contemplated.

The printer head 12 may include the electrode connector 92 configured to electrically couple with the voltage source 30 (not depicted in FIG. 5) and/or the pressure regulator 32 (not depicted in FIG. 5) of the printing system 10. In some examples, an electrical connector in electrical communication with the voltage source 30 may be inserted into an inlet 99 and electrically and/or mechanically connected with the electrode connector 92 to provide voltage and/or other suitable power to the discharge electrode 62 from the voltage source 30 in accordance with control signals from the controller 18 (not shown in FIG. 5). The electrode connector 92 may be any suitable electrical connector including, but not limited to, a plug receptacle, a USB port, a USB-C port, and/or other suitable electrical connectors.

The printer head 12 may be coupled with the pressure regulator 32 in any suitable manner. In some examples, an inlet 94 may be fluidly coupled with the pressure regulator 32, such that the pressure regulator 32 may monitor, maintain, and/or adjust a pressure within the nozzle 22. In some examples, a tube may mechanically couple the pressure regulator 32 with the printer head 12 proximate the inlet 94. Other suitable configurations of the coupling between the pressure regulator 32 and the printer head 12 are contemplated.

The printer head 12 may include a cover 89. In some examples, the cover 89 may at least partially define the inlet 99, while electrically insulating and/or sealing the electrode connector 92 within a housing 25 of the printer head 12. In some examples one or more cover connector locations 87 in the housing 25 may be configured to receive a bolt and/or other suitable connector for engagement with the cover 89. The housing 25 may include one or more closure locations 91, where each of the closure locations 91 may be configured to receive a bolt or other closure component configured to engage the housing 25 and prevent air and/or ink leakage from the printer head 12.

Although it may be desirable to omit a ground electrode from use in creating an electric field across the ink in the nozzle 22, illustrative configurations of the printer head 12 may include one or more selectively usable ground electrodes to improve a stability of the electric field across the ink in the nozzle 22 and/or for other purposes. In some examples, utilizing a ground electrode with the nozzle 22 may be advantageous to maintain a desired electric field through the ink in the nozzle 22 when a standoff distance between the discharge opening 28 and a surface at which a print is to be made is greater than a threshold distance and/or is changing throughout a print.

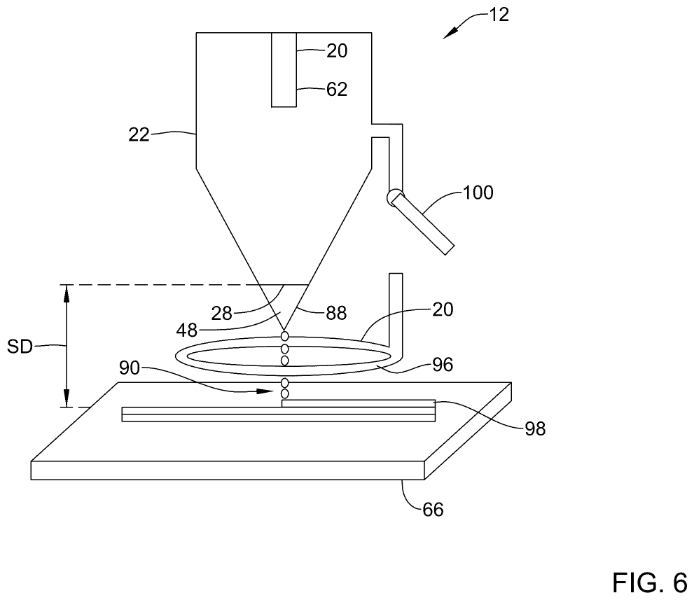

FIG. 6 schematically depicts an illustrative configuration of the printer head 12, where the one or more electrodes 20 of the nozzle 22 include the discharge electrode 62 and a ground electrode 96 (e.g., a support electrode). In some examples, the ground electrode 96 may be configured to be positioned between the nozzle 22 and the substrate 66 on which the print 98 is formed, where the ground electrode 96 may be located so as to not interfere with other printing tools. The ground electrode 96 may be electrically exposed to the nozzle 22 such that the ground electrode 96 facilitates creating and/or maintaining a stable electric field through the ink in the nozzle 22 when enabled.

The ground electrode 96 may have any suitable configuration. In one example, the ground electrode 96 may be a ring electrode coupled with and/or relative to the nozzle 22, but other suitable configurations of the ground electrode 96 are contemplated. In some examples, the ground electrode 96 may be fixed relative to the nozzle 22. When the ground electrode 96 is a ring electrode, the ground electrode 96 may be coupled with and/or with respect to the nozzle 22 such that the ink 48 discharged from the nozzle 22 is discharged through an opening within the ring of the ground electrode 96 (e.g., the ink 48 may be discharged through a central opening of the ground electrode 96).

The ground electrode 96 may be spaced any suitable distance from the discharge opening 28 of the nozzle 22. For example, the ground electrode 96 formed as a ring electrode or formed in one or more other suitable configurations may be maintained at a known and/or fixed distance (e.g., at a known and/or fixed axial distance) relative to the discharge opening 28. In some examples, the known and/or fixed distance may be a distance that is configured maintain a desired electric field through the ink in the nozzle during a printing process for producing a desired print.

The ground electrode 96 may be coupled with any suitable ground. In one example, the ground electrode 96 may be coupled with a ground of the voltage source 30 (not depicted in FIG. 6) and/or other suitable ground of or in communication with the printing system 10.

The illustrative configuration of the printer head 12 depicted in FIG. 6 may include a switch 100 between the ground electrode 96 and a ground for selectively enabling the ground electrode 96. Although one end of the switch 100 is depicted in FIG. 6 as extending from the nozzle 22, the switch 100 may extend between the ground of the voltage source 30 and the ground electrode 96, where the switch 100 may be coupled with the ground through the nozzle 22 and/or independent of the nozzle 22. Although the switch 100 is depicted as being part of the printer head 12, the switch 100 may be a component of the printing system 10 separate from the printer head 12.

The switch 100, when included, may be used to turn off the ground electrode 96 under certain condition and turn on the ground electrode 96 under different conditions. For example, the printer head 12 may be utilized to print 2D patterning with low viscosity ink and 3D patterning with high viscosity ink and turning the switch 100 off during 2D patterning with low viscosity ink may prevent or mitigate the chances of creating an electrical shock at the printing system 10 when a high voltage is accidentally applied to the nozzle 22 due to a system error or other situation and in response, a large amount of ink discharges from the nozzle 22 and submerge the ground electrode 96. With a typical high viscosity ink used for 3D printing, the ground electrode 96 may be switched-on because ink inadvertently being applied to the ground electrode 96 is less likely, as high viscosity ink typically will not splatter uncontrollably in response to an unexpected high voltage.

When in a closed position or configuration, the switch 100 may enable the ground electrode 96 to operate as a ground for the voltage applied to the ink 48 in the nozzle 22 via the discharge electrode 62 and may assist in creating an electric field through the ink between the discharge electrode 62 and the ground electrode 96. When in an opened position or configuration as depicted for example in FIG. 6, the switch 100 disables the ground electrode 96 from operating as a ground for the voltage applied to the ink 48 in the nozzle 22 and interrupts the electric field between the discharge electrode 62 and the ground electrode 96. When the switch 100 is in the opened position or configuration, the discharge electrode 62 may apply a voltage and/or an electric field to the ink 48 in the nozzle 22 independent of the ground electrode 96 to initiate and/or maintain a jet of the ink 48 discharged from the nozzle 22.

The ground electrode 96 may be enabled and utilized as a ground at any suitable time for effecting or executing a print. In some examples, when printing a single layer of ink or less than a threshold number of layers of or less than a threshold thickness of ink, the electric field through the ink in the nozzle 22 may be sufficiently stable throughout the printing process due to an anticipated small and relatively constant standoff distance SD during a printing process. However, when printing a 3D print and/or in other instances, the standoff distance SD may be relatively increased and/or variable such that the standoff distance SD may reach or go beyond the threshold distance, which may cause the electric field through the ink from the voltage applied by the discharge electrode 62 to weaken relative to when the standoff distance SD is small and/or stable. As such, the switch 100 may be adjusted to the closed position or configuration to utilize the ground electrode 96 as a ground for the electric field passing through the ink in the nozzle 22 when the standoff distance is anticipated to be variable and/or reach or go beyond the threshold distance to maintain a desired strength of the electric field through the ink, which may ensure stable and/or consistent printing throughout the printing process. In some examples, the ground electrode 96 may be configured to be spaced a distance (e.g., an axial distance parallel to the standoff distance SD) from the discharge opening 28 that is less than the threshold distances, but the ground electrode 96 may be spaced other suitable distances from the discharge opening 28 as discussed herein.

The threshold distance may be any suitable distance to ensure a desired electric field through the ink in the nozzle 22 is maintained during a printing process for producing a print. In some examples, the threshold distance may be based at least in part on a diameter of the discharge opening 28, but other suitable configurations are contemplated. In one example, the threshold distance may be about 100 microns and/or other suitable distances when a diameter of the discharge opening 28 is about 30 microns, but other suitable threshold distances are contemplated.

The switch 100 may be actuated in any suitable manner. In one example, the switch 100 may be actuated between the closed position and the opened position in response to one or more control signals from the controller 18 based on one or more expected standoff distances SD and/or other suitable factors. In one example, the controller 18 may be configured to adjust the switch 100 to an opened position when a standoff distance SD between the nozzle 22 and a surface to which the ink is to be applied is less than the threshold distance and to adjust the switch to the closed position when the standoff distance is equal to or greater than the threshold. In one example, the switch 100 may be manually actuated.

FIG. 7 depicts a schematic diagram of an illustrative configuration of electrical connections between one or more electrodes 20 and the voltage source 30 of the printing system 10. In some examples and as discussed, the discharge electrode 62 may be electrically coupled with the voltage amplifier 56 and the ground electrode 96 (e.g., a ring electrode and/or other suitable configuration of an electrode) may be electrically coupled with a ground of the voltage amplifier 56 and/or a ground of another component of the voltage source 30. Further, the switch 100 may be positioned in the electrical path between the ground electrode 96 and the voltage amplifier 56 to enable the ground electrode 96 when the switch 100 is in the closed position or configuration and to disable the ground electrode when the switch 100 is in the opened position or configuration.

In some examples and as depicted in FIG. 7, an illustrative configuration of the printer head 12 may include an insulating layer 102 extending entirely or at least partially around a perimeter of the nozzle 22. The insulating layer 102 may facilitate establishing and/or maintaining a desired electrical field across the ink in the nozzle 22 and/or may be provided for other suitable purposes. In some examples, the material of the insulating layer 102 may extend between the nozzle 22 and the ground electrode 96, as depicted for example in FIG. 7, but other suitable configurations are contemplated.

The insulating layer 102 may be formed from any suitable electrically insulating material configured to facilitate establishing and/or maintaining the desired electric field across the ink in the nozzle 22. Example suitable electrically insulating material includes, but is not limited to, plastics, ceramics, silicone rubber, mica, glass, and/or other suitable electrically insulating materials.

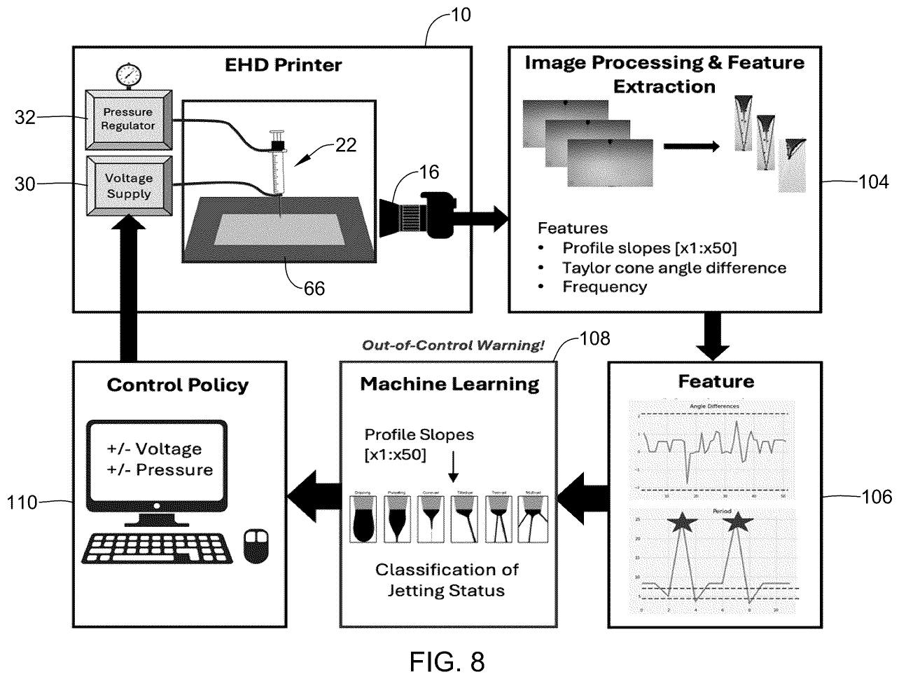

FIG. 8 is a schematic diagram of an illustrative closed-loop control scheme for controlling operation of the printing system 10, which may be implemented via the controller 18 and/or other suitable controllers (e.g., other controllers in communication with the controller 18). The control scheme may rely on images captured by the imager 16 (e.g., a high-speed camera and/or other suitable imager), user input (e.g., print parameters, etc.), and/or other suitable data from the printing system 10. In some examples, the images captured by the imager 16 may be configured to capture a cone and/or jet of ink discharged from the nozzle 22, an image of a print being produced by the ink discharged from the nozzle 22 and applied to the substrate 66, and/or suitable features for monitoring and/or analyzing during the printing process.

The controller 18 may perform 104 image processing and feature extraction using one or more algorithms (e.g., one or more computer vision algorithms, machine learning algorithms, etc.) When the images from the imager 16 are of scenes including the cone 88 and/or the jet 90 of ink 48 discharged from one or more nozzles 22, any suitable features related to the cone 88 and/or the jet 90 may be extracted from the images. For example, the one or more algorithms may be configured to detect each cone 88 and/or jet 90 in an image and measures a profile (e.g., a profile slope) of the cone 88 and/or the jet 90, a frequency or period of the cone 88 and/or the jet 90 (e.g., where frequency=1/period of time between cones or jets), an angle of the jet 90 relative to a direction perpendicular to a printing surface (e.g., a surface of a substrate), a calibrated angle of the jet 90, an angle of the jet 90 in one or more other images, an angle of the cone 88 relative to a direction perpendicular to a printing surface (e.g., a surface of a substrate), a calibrated angle of the cone 88, an angle of the cone 88 in one or more other images, a cone height, a cone area, and/or a measure of one or more other suitable features in the images. In some examples, a profile of the cone 88 and/or the jet 90 may be or may include an angle of the cone 88 and/or the jet 90 and/or a frequency of the cone 88 and/or the jet 90, among other suitable parameters. In some examples a profile of the cone 88 may be or may include measures related to points along a perimeter of the cone 88 (e.g., a height of the points, a length between the points, an angle between points, etc.) The locations of the points along the cone 88 may be selected in any suitable manner.

Any suitable analysis may be utilized for determining a jetting status and to detect whether the jet 90 is stable in a cone-jet mode (e.g., a mode at which the electric field across the ink of the cone 88 reaches a threshold such that a steady emission of the jet 90 occurs). In some examples, statistical Process Control (SPC) charts may be used 106 to determine the jetting status and to detect whether the jet 90 is stable in a cone-jet mode. Other suitable techniques for analysis may be utilized for assessing a jetting status. Example jetting statuses include, but are not limited to, a dripping mode, a pulsating mode, the cone-jet mode, a tilted-jet mode, a twin-jet mode, a multi-jet mode, and/or other suitable modes, as depicted left-to-right in the classification box 108.

The status of the cone 88 and/or the jet 90 may be determined in one or more suitable manners. For example, the frequency of the jets 90, differences between angles of the cones 88, an average of a left angle of the cone 88, an average of the right angle of the cone 88, and/or other suitable parameters may be utilized for classifying the cones 88 and/or the jets 90 and determining a status of the cones 88 and/or the jets 90. In some examples, an angle of a cone may be determined by taking a difference between a right angle and a left angle as measured in a 2D image of the cone. The right angle may be an angle measured between a horizontal line extending through a distal-most center point of the cone 88 and a line between the distal-most center point of the cone 88 and a right-most point on the cone 88. The left angle may be an angle measured between the horizontal line extending through the distal-most center point of the cone 88 and a line extending between the distal-most center point of the cone 88 and the left-most point on the cone 88. If the difference between the left angle and the right angle exceeds or goes beyond a threshold value, the cone 88 may be determined to be out of control and/or classified based on such a determination.

If the measured profile and/or other measured parameters of the cone 88 and/or the jet 90 or jetting frequency are out of control (e.g., goes beyond one or more thresholds, for example, as may be represented in one or more SPC charts and/or other suitable analyses), a machine learning algorithm may classify 108 the jetting mode as not being in the cone-jet mode (e.g., may classify the jetting mode as being a mode other than the cone-jet mode) and initiate control 110 of the pressure and/or voltage (e.g., via a proportional-integral-derivative (PID) controller and/or other suitable control mechanism of the controller 18 or other controller) to achieve and/or restore stability to the jet 90 and the printing process by adjusting one or more parameters (e.g., adjusting a backpressure in the nozzle 22 via the pressure regulator, adjusting a wave, frequency, amplitude, etc. of voltage applied to the ink in the nozzle 22, and/or adjusting one or more other suitable parameters) such that the cone 88 and/or the jet 90 achieves, returns to and/or is maintained in the cone-jet mode. As depicted in FIG. 8, the mode of the jet 90 has been classified as being in a tilted-jet mode, which is identified as being an “out-of-control” condition and a warning by the controller 18 may be issued. In response, one or more of the parameters for producing the jet 90 may be adjusted or controlled 110 to adjust the jet 90 such that the jet 90 achieves the cone-jet mode. One or more iterations of the control loop depicted in FIG. 8 may be required to adjust the jet 90 to the stable cone-jet mode.

FIG. 9 depicts an illustrative software screen 120 of a control system implemented by the controller 18 that includes images and SPC charts of a stable cone 88 and/or jet 90 of ink 48. The upper left of the screen 120 depicts an image 122 of the cone 88 and the jet 90 of the ink 48, which was captured by the imager 16. The upper right of the screen 120 depicts an image 124 with a computer vision algorithm applied to the cone 88 and the jet 90 of the ink 48 discharging from the nozzle 22 for measuring and analyzing one or more parameters of the cone 88 and/or the jet 90 (e.g., angle differences of the jet 90, a frequency or period of the jet 90, etc.) The lower left of the screen 120 depicts an illustrative configuration of an SPC chart 126 with the angle of the jet 90 from a centerline (y-axis) (e.g., a profile of the jet 90) graphed over time (x-axis) (e.g., periods of time and/or consecutive images over time), where an upper threshold angle-difference value 112 and a lower threshold angle-difference value 114 are on the chart 126. As depicted, the angle of the jet 90 is in control between the upper threshold angle-difference value 112 and the lower threshold angle-difference value 114. The lower right of the screen 120 depicts an illustrative configuration of an SPC chart 128 with the period of the jet 90 graphed over time (e.g., periods of time and/or consecutive images over a period of time), where an upper threshold period value 116 and a lower threshold period value 118 are on the chart. As depicted, the period of the jet 90 is in control between the upper threshold period value 116 and the lower threshold period value 118. As the jet 90 has an angle that is within set thresholds for the angle and a period within set thresholds for the period, the jet 90 may be classified as being in a stable cone-jet mode.

FIG. 10 depicts an illustrative software screen 130 of a control system implemented by the controller 18 that includes images and SPC charts of an unstable cone 88 and/or jet 90 of ink 48. The upper left of the screen 130 depicts an image 132 of the cone 88 and the jet 90 of the ink 48, which was captured by the imager 16 and depicts the jet 90 offset to the right of a centerline perpendicular to the substrate 66. The upper right of the screen 130 depicts an image 134 with a computer vision algorithm applied to the cone 88 and the jet 90 of the ink 48 discharging from the nozzle 22 for measuring and analyzing one or more parameters of the cone 88 and/or the jet 90. The lower left of the screen 130 depicts an illustrative configuration of an SPC chart 136 with the angle of the jet 90 from a centerline (y-axis) (e.g., a profile of the jet 90) graphed over time (x-axis) (e.g., periods of time and/or over consecutive images over a period of time), where the upper threshold angle-difference value 112 and the lower threshold angle-difference value 114 are on the chart 136. As depicted, the angle of the jet 90 is in not within control values and extends beyond the upper threshold angle-difference value 112 and the lower threshold angle-difference value 114. The lower right of the screen 130 depicts an illustrative configuration of an SPC chart 138 with the period of the jet 90 graphed over time (e.g., periods of time and/or consecutive images over a period of time), where the upper threshold period value 116 and the lower threshold period value 118 are on the chart. As depicted, the period of the jet 90 is not within control values between the upper threshold period value 116 and the lower threshold period value 118. In response to the jet 90 being out of control in both angle and period (or frequency), the controller 18 may be configured to issue an alert or warning and/or automatically adjust operation of the pressure regulator 32, the voltage source 30, and/or other suitable parameters to correct the out of control jet 90 such that jet 90 may be classified as being in a stable cone-jet mode.

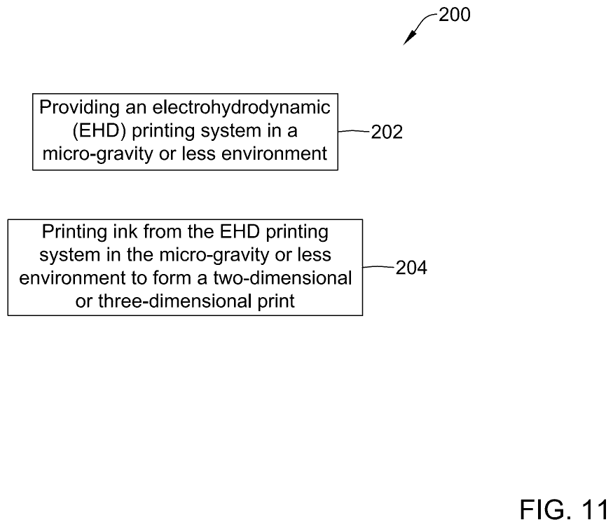

FIG. 11 depicts an illustrative technique or method 200 for printing ink in a micro-gravity or less environment (e.g., a zero-gravity environment, etc.) The method 200 may include providing 202 an EHD printing system in a micro-gravity or less environment. In one example, the EHD printing system (e.g., a groundless EHD printing system as described herein, which may include a selectively grounded EDH printing system as described herein, and/or other suitable EHD printing system) may be provided in a micro-gravity or less environment on Earth and/or in space.

The method 200 may further include printing 204 ink from the EHD printing system in the micro-gravity or less environment to form a two-dimensional and/or three-dimensional print. In some examples, the printing 204 in the micro-gravity or less environment may be performed without a ground electrode at or proximate the substrate on which a print is formed from the printing and/or without enabling a ground electrode proximate a nozzle of the EHD printing system that is configured to receive voltage and/or an electric field applied to ink in the nozzle. Further, a closed loop control of the printing process that utilizes images of ink discharged from a printer and computer vision analyses and/or other data analyses may facilitate maintaining a stable printing process while printing in the micro-gravity or less environment.

Printing the ink from the EHD printing system in the micro-gravity or less environment may include one or more sub-steps. In some examples, a printing process may be initiated by receiving printing parameters for a print (e.g., from user input, etc.) The ink may then be printed in accordance with and/or to achieve the printing parameters by developing control signals for and outputting the control signals to a pressure regulator, a voltage source, and/or other suitable components of the EHD printing system. The control signals may cause the pressure regulator to apply a pressure (e.g., a backpressure) to ink in the nozzle of the printing system and the voltage source to apply a voltage to the ink in the nozzle to create an electric field across the ink. The pressure and voltage applied to the ink may be configured to cause the ink to be discharged through a nozzle opening of the nozzle in the micro-gravity or less environment and discharge in a stable, consistent, predictable manner onto a surface to create a print. When closed loop control of the printing process is utilized (e.g., as discussed herein or otherwise), the EHD printing system may continuously ensure the printing process is stable such that any print produced is within predetermined tolerances and material waste is mitigated by monitoring and analyzing images of the discharged ink and/or other received data.

As discussed, the ink printed from the EHD printing system may be any suitable type of material. In some examples, the printed ink may be a material selected from a group consisting of conductive material, semi-conductive material, and insulating material. Other types of ink material may be utilized as desired.

Any suitable parameters may be utilized when printing ink from the EHD printing system in the micro-gravity or less environment according to the method 200. In some examples, the following parameters may be utilized for printing ink from the EHD printing system in the micro-gravity or less environment to achieve a desired print: a voltage in a range from 0 kilovolts (kV) (AC and/or DC) to 5 KV, any suitable voltage waveform patterns (e.g., steps, sinusoidal, and/or other suitable patterns), a standoff distance in a range from 0 mm to 1000 mm, a back pressure in a range from 0 psi to 1 psi, a discharge opening diameter in a range from 1 micron to 500 microns, a jet frequency in a range from 0 kilohertz (kHz) to 500 kHz, a duty cycle in a range from 0% to 100%, and/or other suitable values of other suitable parameters.

The present disclosure may be manifested in a variety of forms other than the specific configurations described and contemplated herein. Accordingly, departure in form and detail may be made without departing from the scope and spirit of the present disclosure as described in the appended claims.

What is claimed is:

1. An electrohydrodynamic printing system, comprising:
a nozzle including a nozzle opening, the nozzle is configured to contain ink and discharge the ink through the nozzle opening;
a discharge electrode configured to be in electrical communication with ink in the nozzle to apply voltage to the ink and create a jet of the ink discharged from the nozzle opening;
a voltage source configured to apply the voltage to the discharge electrode;
an imager configured to image the jet of the ink discharged; and
a controller in communication with the voltage source and the imager, and
wherein the controller is configured to analyze images from the imager of the jet of the discharged ink, configure control signals for the voltage source for controlling the voltage applied to the discharge electrode to initiate the jet of the ink discharged from the nozzle opening based on the analysis of the images, and output the control signals to the voltage source.

2. The system of claim 1, wherein the controller is configured to compare a profile of the jet of the ink discharged in the image to one or more thresholds and output the control signals to the voltage source based on the comparison of the profile of the jet of the ink discharged in the image to the one or more thresholds.

3. The system of claim 1, wherein:
the imager is configured to image each of a plurality of jets of the ink discharged over a period of time, and
the controller is configured to compare a period of the jets of the ink discharged over the period of time in the images to one or more thresholds and output the control signals to the voltage source based on the comparison of the frequency of the images of the jet of the ink discharged over the period of time to the one or more thresholds.

4. The system of claim 1, further comprising:
a pressure regulator in communication with the controller and configured to control a pressure applied to the ink in the nozzle, and
wherein the controller is configured to output control signals to the pressure regulator for controlling the pressure applied to the ink in the nozzle based on the analysis of the images.

5. The system of claim 1, further comprising:
an illumination source, wherein the illumination source is configured to illuminate a target area for the imager and the target area includes the jet of the ink discharged from the nozzle.

6. The system of claim 1, further comprising:
a groundless stage configured to receive a substrate having a surface to which the ink discharged from the nozzle is to be applied.

7. The system of claim 6, wherein the groundless stage is adjustable in three dimensions.

8. The system of claim 1, further comprising:
a nozzle adjustment system, wherein the nozzle adjustment system is configured to adjust a position of the nozzle in three dimensions.

9. The system of claim 1, further comprising:
a ground electrode configured to create an electric field with the discharge electrode.

10. The system of claim 9, further comprising:
a switch having a closed position in which the electric field is created between the discharge electrode and the ground electrode and an opened position in which the electric field between the discharge electrode and the ground electrode is interrupted.

11. The system of claim 10, wherein the switch is in communication with the controller and the controller is configured to adjust the switch to an opened position when a standoff distance between the nozzle and a surface to which the ink is to be applied is less than a threshold value and to adjust the switch to the closed position when the standoff distance is equal to or greater than the threshold value.

12. The system of claim 1, wherein the controller is configured to output control signals to the voltage source to initiate one or more jets of ink to create a two-dimensional or three-dimension print in a micro-gravity or less environment.

13. A nozzle head assembly for an electrohydrodynamic printing system, the assembly comprising:
a nozzle including a nozzle opening, the nozzle is configured to contain ink and discharge the ink through the nozzle opening;
a discharge electrode configured to be in electrical communication with ink in the nozzle to apply voltage to the ink and create a jet of the ink discharged from the nozzle opening;
an electrical connector in electrical communication with the discharge electrode, the electrical connector is configured to electrically connect with a voltage source, and
wherein the nozzle and the discharge electrode are configured to discharge the ink in the jet of the ink independent of a ground electrode.

14. The assembly of claim 13, further comprising:
a ground electrode configured to create an electric field with the discharge electrode.

15. The assembly of claim 14, further comprising:
a switch having a closed position in which the electric field is created between the discharge electrode and the ground electrode and an opened position in which the electric field between the discharge electrode and the ground electrode is interrupted.

16. The assembly of claim 13, further comprising:
a mechanical connector coupled with the nozzle and configured to releasably engage a support on a printer system.

17. The assembly of claim 13, wherein the nozzle is configured to output one or more jets of ink to create a two-dimensional or three-dimensional print in a micro-gravity or less environment.

18. A method of printing ink in a micro-gravity or less environment, the method comprising:
printing ink from an electrohydrodynamic printing system in the micro-gravity or less environment to form a two-dimensional or three-dimensional print.

19. The method of claim 18, wherein printing ink from the electrohydrodynamic printing system in the micro-gravity or less environment comprises:
applying a pressure to ink in a nozzle having a nozzle opening through which the ink is printed;
applying a voltage to the ink in the nozzle without using a ground electrode to receive the voltage applied to the ink, and
wherein the pressure and the voltage are configured to print the ink through the nozzle opening in the micro-gravity or less environment.

20. The method of claim 18, wherein the ink is a material selected from a group consisting of conductive material, semi-conductive material, and insulating material.
